(19) United States
(12) Patent Application Publication
(10) Pub. No.: US 2002/0170318 A1
(43) Pub. Date: Nov. 21, 2002

(54) Brief summary of the invention

(76) Inventors: Andreas Gartner, Melbourne, FL (US); Anthony P. Pappalardo, Palm Bay, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 09/823,317

(22) Filed: Apr. 2, 2001

(51) Int. Cl. C03B 21/06

(52) U.S. Cl. 65/105; 65/166

(57) ABSTRACT

A method and apparatus for the rapid sectioning of hollow cylindrical bodies by means of coherent light. The method applies to nonmetallic substances under special consideration of glass.

### BRIEF SUMMARY OF THE INVENTION

The invention relates to a method to section hollow cylindrical bodies by applying a balanced heat system on the apex of the rotating cylindrical body to create thermo-mechanical fatigue which ultimately leads to a controllable rate of separation from the main body. A cylindrical body is spun on either a centerless 2 point friction assembly or centered in a chuck or equivalent mechanical means with a radial speed equivalent to the ratio of 1200 to 2500 over the radius of the hollow cylinder. The ratio depends on the material characteristics and in particular the thermal expansion coefficient as well as the specific heat. On the apex of the rotation of such cylindrical body a heat system consisting of a heat source as well as a balance system is placed, which projects a heat plane in three dimensions, using the apex in either center position of slightly to the one side of the projection center and overlaps with the balance system toward the opposite side. The balanced heat system is sustained for a time t, which is described in relation to the positive and negative heat flux as well as the material properties. The interaction time t, in it's definition via the flux rates and the material properties allows a convenient process control in terms of the sectioning rate, which can be adjusted from 80 (weak scribe) to 0 percent (full sectioning) of the initial material cohesion.

### BRIEF DESCRIPTION OF DRAWINGS

FIG. 1. illustrates the three-dimensional projection of the primary heat flux system as well as the balance system with their coinciding areas.

FIG. 2. shows the functional components of the preferred embodiment.

### BACKGROUND OF THE INVENTION

Presently, the mass production of cylindrical shaped bodies such as straight wall bulbs or fluorescent lamps relies on either bursting or breaking methods, where a weak point or scribe line is created on the inside or outside surface of a cylindrical body which in turn is used to start a fissure, mostly by mechanical means. It is also known to soften the material sufficiently and then either pull the sides apart to further reduce the thickness in the heated area until the material separates or melt the material with constant heat supply, mostly by using torches.

Inevitably a bead is formed along the then separated faces of the cylindrical bodies where a significant increase of the wall thickness can be observed. Prior art also describes the use of laser sources to evaporate the material along the separation line. As such evaporation cannot be conducted without melting adjoining material, a bead forms as well along with a significant stress introduced in the material.

Caffarella et al. (U.S. Pat. No. 4,146,380) teaches a technique to heat a gas filled tube with a laser until the material softens, in turn pull the sides apart and seal the collapsed segments. Ilk (U.S. Pat. No. 4,185,419) showed a bursting method, in particular for shaft or stem glasses. Hofmann (U.S. Pat. No. 4,247,319) teaches a process to heat glass tubes to softening temperature and shape them. Morgan (U.S. Pat. No. 4,467,168) described a method to focus a laser beam on a surface and vaporize the first thickness of glass to create a hole throughout the material thickness.

Lynch (U.S. Pat. No. 4,477,273) taught a process where a heat zone is created by a torch in a rotary path of travel. Steinhoff (U.S. Pat. No. 4,606,747) described a method to put a partially absorbent material between a laser beam source and the article and evaporate by using the so formed mask as a pattern. Clark et al. (U.S. Pat. No. 4,631,079) taught the repeated heating and stretching of a glass rod. Minakawa et al. (U.S. Pat. No. 4,682,003) shows a method to heat a glass article (for example a molded tumbler having a moil) with a laser beam while a downwardly directed force is applied and subsequently to “fire-polish” the edge with a gas burner. Flaming (U.S. Pat. No. 4,913,719 as well as U.S. Pat. No. 4,921,522) showed a process to soften the glass by means of a laser beam and subsequently pull in opposite directions. The process uses a parabolic mirror to uniformly apply the laser radiation along the circumference. Andrews (U.S. Pat. No. 4,111,677) taught a method to rotate a tube vertically and heat it above the vertical center to allow it to stretch by its own mass and form a necked down portion. Belgum (U.S. Pat. No. 5,181,948) uses a laser to heat a length of capillary and pull a micropipette once the softening point is reached. Vetter (U.S. Pat. No. 5,779,753) described a method to shape a glass tube by means of a plurality of laser beams, whereby the first beam is focused to the article's surface and evaporates the material and the other beams are used to reshape, melt or heat-treat the workpiece. Witzmann (U.S. Pat. No. 5,902,368) teaches a method for the heat-softened severance of thin walled glass tubes, whereby a laser is used to heat the glass along the severance line to a temperature above the softening point and subsequently draw the tube apart to form a thin walled piece which is heated again until the thin walls melt.

In summary these processes can be said to either create a glass bead by melting parts of the material, which in turn forms a bead on the segment faces, or try to reduce such bead formation by pulling the material apart once it reached softening temperature to reduce the wall thickness in the area intended to be separated. A bead will form nonetheless, but due to the significantly reduced amount of material present in the severance area it is not as severe.

### DETAILED DESCRIPTION OF THE INVENTION

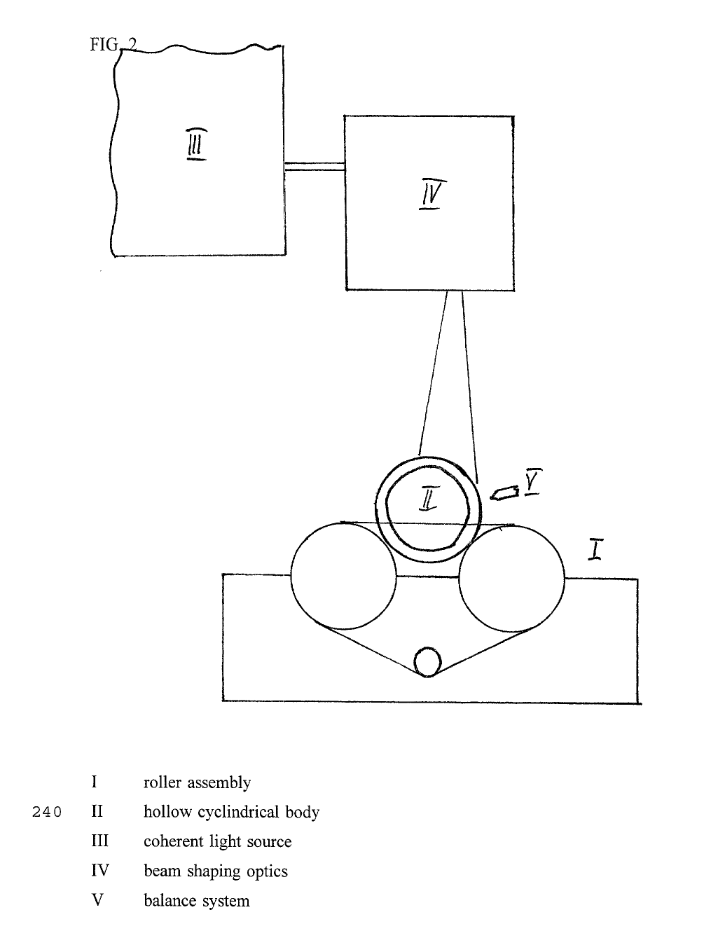

The present invention introduces a method to rapidly section hollow cylindrical bodies. In a preferred embodiment a rotation symmetrical body will be spun relative to a stationary optical path. The optical path consists of a laser source (FIG. 2-III), which might be either continuous or quasi-continuous (high pulsed) as well as various beam shaping lenses (FIG. 2-IV) which subsequently will be described more precisely.

If a quasi-continuous source is used, a pulse period to width ratio of approximately 400 to 100 (microseconds) should be observed for ideal edge properties. Such setting results in a 25 percent duty-cycle of the laser source, which puts it in a very stable range of the expected output power. Different pulse settings are certainly possible but experimentation showed that for most materials the edge quality is best in close proximity to this ratio.

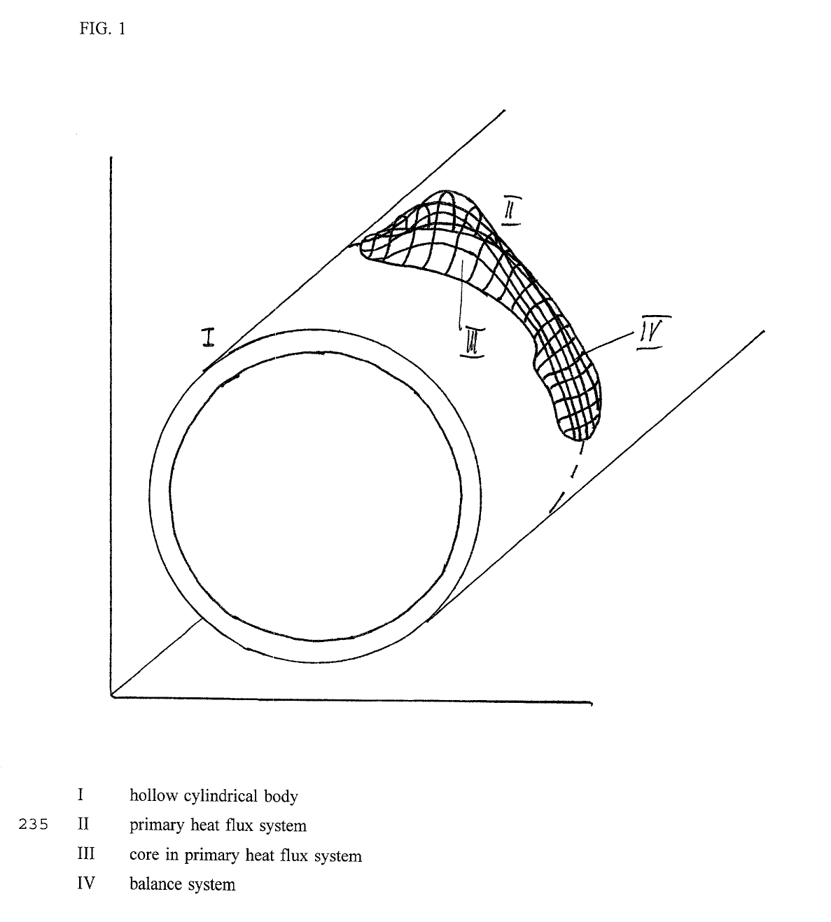

In using industrial laser sources normally a beam diameter of between 4 and 7 mm is encountered, which suits best (with the optical elements used in the preferred embodiment) for a diameter range between 15 and 25 mm of the material intended to be sectioned. For smaller diameters a beam collimator can be used to narrow the beam waist, for larger diameter an expander can be used to enlarge the beam waist. The optical system (FIG. 2-IV) consist of either a single projection lens with several beamshaping devices or a multitude of projection lenses with or without additional beamshaping lenses. A single lens is sufficient for a diameter range between 15 and 25 mm of the material intended to be sectioned. The cylindrical lens as used in the preferred embodiment is placed in the beam path in a way to create a projection along the curved surface of the body, whereby the vertical position of the body in the beam path does not coincide with the focal point of the chosen lens. According to this invention, such projection is a defocused, three-dimensional curved plane, starting counterclockwise ahead of the apex and extending clockwise to between 10 and 90 degrees after apex. From the start of the projection to the apex approximately one quarter of the overall projection length will be consumed, from the apex to the end of the projection the remaining three quarter of the projection length. Inside the beam projection there is a core with higher energy than the surroundings. This core (FIGS. 1-III) extends from the apex to approximately two third of the overall projection length. The core projection inside the overall beam projection dictates the energy distribution. In the core area the energy is by factor 2 to 100 higher than in the surrounding projection are. There is yet another component which governs the energy distribution in three dimensional space as with increasing distance from the focal point the core becomes more defocused. As the body is located between the projection lens and the focal point, the energy density becomes more intense the further clockwise the projection progresses around the body, towards the focal point. As a result, the lower part of the core has a higher specific energy than the upper part around the apex.

The last part of the core (the high energy area) coincides with the begin of the balance system (FIG. 1-IV). The balance system (also FIG. 2-V) actually removes heat from the body, either by using a gas with sufficient heat storage and transport ability (for example, but not limited to, Helium) or compressed air with a fine mist of water, alcohol, a mixture of both or organic fluids with high thermal capacity as known in the art. The projection area of the balance system has a core as well, which is formed by virtue of the particle distribution in the stream. The present invention used an applicator designed to create a round pattern in concentric rings around a high intensity center. Such center of the balance system coincides with the high energy part of the primary heat flux system's core. This in turn results in an extremely fast changing flux pattern, which creates thermo-mechanical fatigue. The extent of such fatigue can be controlled by the heat flux densities in the primary respectively the balance system to control the degree of sectioning. In our experiments we were able to show a all stages of separation between 15 and 100 percent. An additional factor is represented by the radial displacement speed, so how fast material can be provided to the heat flux systems.

We experienced that a radial speed represented as a ratio of 1200 to 2500 over the radius of the body for diameters between yields excellent results in terms of edge quality in the separation, be it 100 percent separated or separated to a degree less than 100 and broken manually. The process is by no means limited to this ratio, but the resulting edge quality deteriorates outside this range for most materials. The selection of the proper ratio depends on the material characteristics. Materials with high values for thermal expansion need less heat flux and therefore if all other parameters are held constant, more radial speed. Materials with high values for the thermal capacity need more heat flux and therefore if all other parameters are being held constant, less radial speed. Certainly, in an industrial embodiment the parameter needs to be selected which allows best process control least setup times. Depending on the chosen construction for the device which spins the cylindrical body underneath the stationary optics it might be simpler to instead of changing the radial speed vary the laser power to a degree to achieve the same result. The laser power to achieve 100 percent sectioning on a for example 25 mm diameter body with a wall thickness of 0.8 mm is approximately 50 Watts. For bodies with higher wall thickness the required laser power can be between 51 and 250 W, as a function of the material properties as well as the desired radial speed. Certainly higher laser power is possible but according to this invention only useful for extreme applications. As a preferred embodiment can accommodate various diameters of bodies, the vertical height of the optical system relative to the apex point of the body needs to be adjustable, to create a projection in the specified dimension of approximately 100 degree of the circumference of the body.

The length of the hollow cylindrical body is of no relevance to the present invention. When the cylindrical body is spun on the roller assembly (I) or in a chuck some means of linear movement are incorporated, either by using a linear stage or an incremental drive which laterally moves the body relative to the stationary optics. The lateral displacement is equivalent to the desired length of the formed section. The rotational motion system is in constant motion as long as there is material available on the body which needs to be sectioned off. The lateral motion system displaces for the desired amount and comes to a complete stop in the desired position. Once the lateral motion system stopped, the optical system takes over and launches a pre-programmed cycle. Such cycle consists of a sectioning initiation, opening the shutter located between laser source and optical system to allow the beam to pass to the shaping and projection system and eventually to impinge on the body in a way we already described. Shortly after the balance system comes on and removes heat from the laser trail. This procedure continues for one or more revolutions until the desired sectioning depth is achieved. Then the shutter closes to retract the projection from the body and the balance system also stops shortly thereafter. The timings between these events are critical for the process and are therefore carefully measured. The initiation of the sectioning can be done by means of various simple methods. We conducted experiments where an abrasive cloth was brought in contact with the bodies surface for a short time. There was no visible affect, at least not for the un-aided eye. Under a suitable microscope tiny scratches could be seen on the material surface. This proved already sufficient to reliably start the sectioning process. Another method made use of a small piece of a material harder than the material to be sectioned, and applied this material (for example sapphire) for a short time on a tangent to the body which left a small, barely visible scratch. The forces involved here were only a few milli-Newton and the application time did not exceed 20 milliseconds. Certainly higher forces and longer application times are possible but neither wanted nor necessary. Yet another method which was successfully applied to initiate the sectioning was a short pulse from a laser, whereby in our experiments a pulse width of 50 microseconds in a pulse period of 100 microseconds, focused between the upper and lower surface of the material at the apex point, or at any other point desired and applicable could be used to repeatedly initiate the process. Yet another method, which though yielded less than hundred percent initiation repeatability was the application of focused acoustic energy. A concave transducer head, attached to an ultrasonic generator was positioned somewhere along the circumference of the body and triggered a short impulse of sufficient strength (1000 W generator power), focused on the surface of the body. The location is insofar irrelevant as latest within one revolution such position will inevitably coincide with the apex point. This is certainly true also for the other described methods. The point of initiation ideally coincides with the desired sectioning path, but our experiments also showed that offset initiation will reliably start the process as long as the initiation mark is within close vicinity to the desired path. We gathered experimental data for initiation points as far off as 1000 microns. By increasing the strength of the initiation certainly even further distances can be achieved but the usefulness for the indented purpose is doubtful.

The overall shutter open time dictates the total positive heat flux into the body and needs to be adjusted as a function of the material properties. The total heat flux should just exceed the strain point of the material. The overall balance system open time regulates the heat removal from the body and is also depending on the material properties. In a preferred embodiment these timings are controlled by a computer which in turn controls the valves and other devices such as the motion systems.

### REFERENCES CITED

U.S. Patent documents

| | | |
|---|---|---|
| 4,146,380 | Mar 27, 1979 | Caffarella, et al. |
| 4,185,419 | Jan 29, 1980 | Ilk |
| 4,247,319 | Jan 27, 1981 | Hofmann |
| 4,467,168 | Aug 21, 1984 | Morgan, et al. |
| 4,477,273 | Oct 16, 1984 | Lynch, et al. |
| 4,606,747 | Aug 19, 1986 | Steinhoff |
| 4,631,079 | Dec 23, 1986 | Clark, et al. |
| 4,682,003 | Jul 21, 1987 | Minakawa, et al. |
| 4,913,719 | Apr 3, 1990 | Flaming |
| 4,921,522 | May 1, 1990 | Flaming |
| 4,111,677 | Sep 5, 1978 | Andrews |
| 5,181,948 | Jan 26, 1993 | Belgum |
| 5,779,753 | Jul 14, 1998 | Vetter, et al. |
| 5,902,368 | May 11, 1999 | Witzmann, et al. |

### FEDERALLY SPONSORED RESEARCH/DEVELOPMENT STATEMENT

No federal funds were used in regard with this invention.

### MICROFICHE APPENDIX

No Microfiche Appendix is enclosed.

We claim:

1. A method to create a three-dimensional projection on the surface of a hollow cylindrical body near the apex point, with a distinct energy distribution in a core inside such projection.

2. A method to position a balance system coinciding with the primary heat flux system as described in 1.

3. A method to supply energy to such heat flux systems by using coherent light sources.

4. A method comprising of:
(a) the initiation step by means of either mechanical methods (microscratches on the surface by applying an abrasive cloth or harder materials), pulsed laser sources or focused ultrasonic energy
(b) application of energy by means of using a coherent light source in a delivery suitable to create a three-dimensional beam projection encompassing the apex point and extending between 10 and 90 degrees to both sides with a distinct high energy core.
(c) removal of energy by a balance system which is projected towards the clockwise end of the high energy core by a stream of gas or a stream of gas combined with a fluid mist.
(d) spinning a cylindrical hollow body relative to such projections in a radial speed to match the heat flux patterns of the projection system.
(e) continuation of the process until a remaining cohesion of the sectioned segments between 80 and 0 percent is achieved.

5. An apparatus to spin cylindrical bodies by either using two rollers mounted on a liner motion system or a chuck with a bar feeder system. The displacement of the linear motion system or the pull of the bar feeder yields the desired section length relative to a stationary optical system. A control system governs the timing events of the individual phases of the process.
